(19) United States
(12) Patent Application Publication
(10) Pub. No.: US 2020/0258098 A1
(43) Pub. Date: Aug. 13, 2020

(54) SYSTEMS AND METHODS FOR ENHANCING AND MONITORING DEMAND FORECAST THROUGH ADVANCED ANALYTICS

(71) Applicant: HEWLETT PACKARD ENTERPRISE DEVELOPMENT LP, Houston, TX (US)

(72) Inventors: GILBERTO DAVID GRACIANI, Aguadilla, PR (US); JOSE M. MEJIAS MIRANDA, Aguadilla, PR (US); LUIS RAUL ROMAGUERA, Aguadilla, PR (US); DAVID L. PORTUGAL, Houston, TX (US); BRENT CURTISS THORN, Houston, TX (US); ALEX FERNANDO PINO ORAMA, Aguadilla, PR (US)

(21) Appl. No.: 16/785,356

(22) Filed: Feb. 7, 2020

Related U.S. Application Data
(60) Provisional application No. 62/803,344, filed on Feb. 8, 2019.

(51) Int. Cl. G06Q 30/02; G06N 20/00; G06Q 50/28

(52) U.S. Cl. CPC G06Q 30/0201; G06Q 50/28; G06Q 30/0205; G06N 20/00

(57) ABSTRACT

Methods and system for enhancing and monitoring demand forecasting through advanced analytics is described. The advanced analytics demand forecasting system and techniques leverage multivariate data, thereby enhancing modeling through the use of data related to a plethora of aspects of the supply chain. Multivariate data can include market data, econometric data, customer data, lifecycle analytics, and an expanded range of historical data (e.g., 15 years). Multivariate data can be fed into an advanced analytics hyper parameter model, which combines time series, as well as machine learning and deep learning algorithms to improve the accuracy of the demand forecast. In some cases, the advanced analytics hyper parameter model is a stacking ensemble model, which combines the predictions of several other models using a stacking ensemble technique, thereby improving the modeled predictions. Accordingly, advanced analytics demand forecasting techniques can provide improved accuracy, and advancements over previous univariate approaches.

### RELATED APPLICATIONS

This application claims the benefit of U.S. Provisional Patent Application No. 62/803,344, filed on Feb. 8, 2019, the contents of which is incorporated herein by reference in its entirety.

### DESCRIPTION OF RELATED ART

Commercial enterprises compete for customers by promising low prices, and fast delivery, among other client-driven criteria. Success in a competitive environment often requires careful monitoring of profit margins and deadlines. One key to success in this environment is a system that provides accurate and timely business information. Financial data and other information that indicates the state of the corporation can no longer be examined only on a periodic bases, but rather must be continually monitored. Businesses rely on their latest performance information to support strategic planning and decision making, so any businesses without a system for providing accurate and timely business information would be at a huge disadvantage. Accordingly, it may be desirable to utilize a forecasting system that can accurately predict future values related to the supply chain and various business aspects, such as product demand, based on past values and behavior that have been monitored over time.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A depicts an example of a system distributed across a communications network implementing the advanced analytics demand forecasting techniques according to some embodiments.

FIG. 1B depicts an example of a display for analyzing demand forecasting that may be generated by the system shown in FIG. 1A, implementing advanced analytics demand forecasting, according to some embodiments.

FIG. 1C depicts another example of a display for analyzing demand forecasting that may be generated by the system shown in FIG. 1A, implementing advanced analytics demand forecasting, according to some embodiments.

FIG. 2 illustrates an example of a stacking ensemble model that can be employed in advanced analytics demand forecasting techniques, according to some embodiments.

FIG. 3 is an operational flow diagram illustrating an example of a process for implementing advanced analytics demand forecasting, according to some embodiments.

FIG. 4 illustrates an example computer system that may be used in implementing advanced analytics demand forecasting relating to the embodiments of the disclosed technology.

The figures are not exhaustive and do not limit the present disclosure to the precise form disclosed.

### DETAILED DESCRIPTION

Various embodiments described herein are directed to a method and a system for enhancing and monitoring demand forecast through advanced analytics. As described herein, demand forecasting refers to a form of predictive analytics which tries to understand and predict customer demand, in order to optimize supply decisions by corporate supply chain and business management. Accuracy in forecasting can be critical to an efficient and predictive supply chain system. Due to this importance of accuracy in forecasting, some corporations may set internal goals for an amount of error that is tolerable in their forecast systems. For example, the high tech industry has a median error that is generally experienced in forecast systems used throughout the industry. According to the embodiments, a sophisticated demand predictive model is generated, which further enhances the demand forecast system discloses herein. Thus, the disclosed demand forecast system and techniques may realize improvements over some of the forecast systems currently used in the high tech industry, having a forecast error rate that is lower than the median, and avoids increased cost (e.g., primarily driven by inventory and/or working capital investment reductions), and operations that may continually progress towards best in class performance. Demand forecasting that is improved through multivariate-driven advanced analytics is a unique capability that can lead to a corporation having a leadership position in the industry, and over time, a long term competitive advantage. Furthermore, the disclosed advanced analytics demand forecast system can circumvent lag to class performance, and error goals that are typically associated with demand forecast inaccuracies. Addressing the inaccuracies of demand forecasts (and reducing its impact) can also lead to increased cost efficiency, as some estimates of the costs of such forecast inaccuracies across the supply chain exceed the multi-millions driven by the inventory and/or working capital investment reductions.

As will be discussed in greater detail, the disclosed advanced analytics demand forecast system and techniques leverage various forms of data, such as market data, economic data, customer data, lifecycle analytics, and an expanded range of historical data (e.g., 15 years). This data is fed into a hyper parameter model, which combines time series, as well as machine and deep learning algorithms to improve the accuracy of the system's demand forecast. Forecast accuracy is a critical supply chain metric. It is not uncommon for some demand and supply side critical indicators to be negatively impacted by incorrect (or inaccurate) forecast. Critical indicators relating to the supply chain can include, inventory levels, case to cash cycle, supplier-on-time and customer-on-time delivery. The demand forecast system and techniques can also address limitations to these critical indicators, by improving the overall accuracy of the demand forecast.

Some current forecasting systems and techniques involve a univariate approach. As an example, a univariate approach may use historical demand that is extrapolated from a small window of data (e.g., two to three years) from historical shipments to derive the forecasted future demand. In general, univariate approaches are based on relatively simple statistical models. This can significantly limit the data and insights that can be gleaned/leveraged and sub-optimizes forecast accuracy. However, a typical lifecycle may be longer than the window of data used for historical demands in the univariate approach. For instance, a system lifecycle may be five years, depending on the current position in the lifecycle. In an example of a lifecycle, the demand for a product may rise at the early stages of the lifecycle. Then, later in the lifecycle, after the product becomes more prevalent and familiarity with the product in the market increases, the demand for that product may reach a peak. However, nearing the end of the lifecycle, the demand for that product may experience a decline, as new technology emerges and competition in the market grows. Thus, a univariate approach using a limited window of data, could substantially influence the accuracy, and add error to the model output. Therefore, the disclosed advanced analytics demand forecast system and techniques leverage multivariance, and analytics (as opposed to statistics) to provide improved forecast accuracy, and advancements over previous univariate approaches.

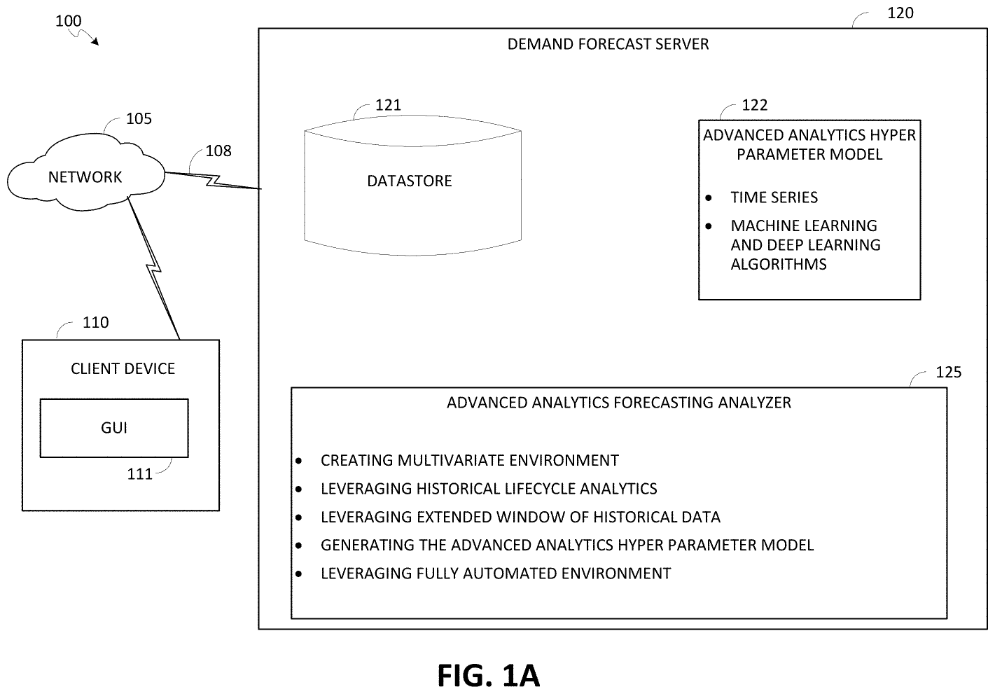

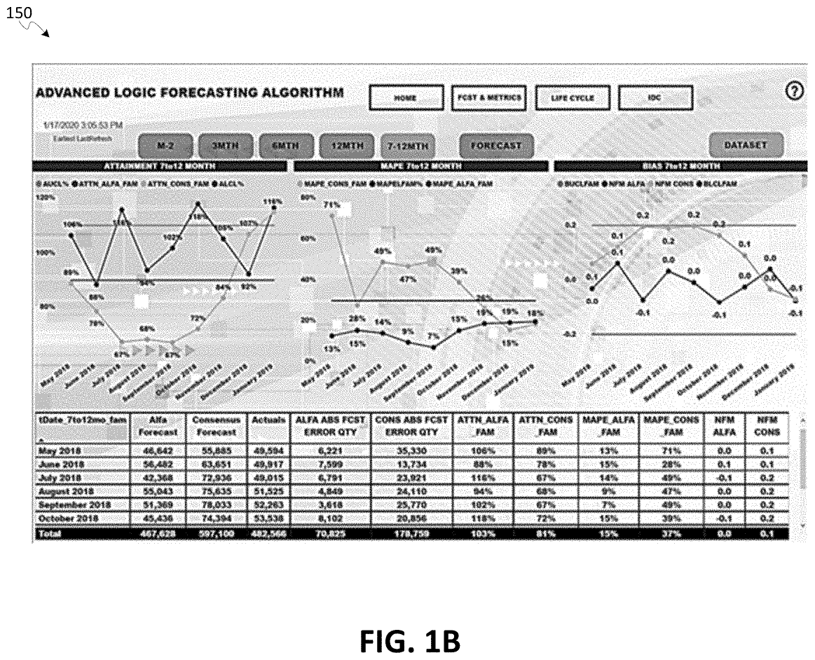

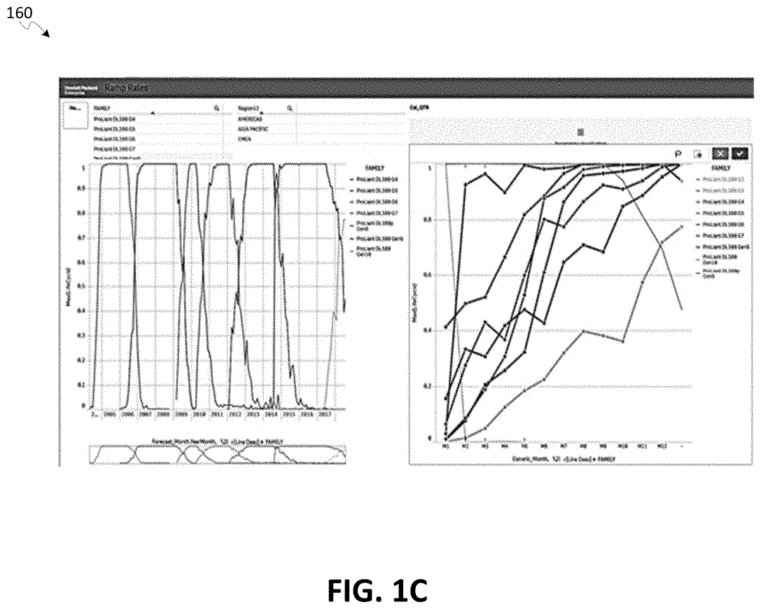

FIG. 1A depicts an example of the advanced analytics demand forecast system 100 distributed across a communications network 105. The advanced analytics demand forecast system 100 is shown to include a client device 110 that is communication with a demand forecast server 120 via the communications network 105. The communications network 105 may be a public Wide Area Network (e.g., Internet) or a private network (e.g., Local Area Network (LAN), Intranet, Ethernet, etc.). The demand forecast server 120 can communicate with multiple client devices, including client device 110, in order to provide the disclosed demand forecast services. In the illustrated example, the demand forecast server 120 is comprised of several components, including: a datastore 121, an advanced analytics hyper parameter model 122, and an advanced analytics forecasting analyzer 125. The client device 110 is illustrated as a mobile device, and can be implemented as a laptop, smartphone, tablet, digital audio players, and the like. However, it should be appreciated that the client device 110 may be other forms of computer devices, such as a desktop computer, and the like.

In an embodiment, the client device 110 can send a request to perform demand forecasting to the demand forecast server 120. The request of the client device 110 may include various information pertaining to desired forecasting. For example, the request may specify the location of multivariate data that may be used for forecasting. The multivariate data for forecasting may be stored in a file or the datastore 121 residing on the demand forecast server 120. The request issued by the client device 110 may specify the path to this file of the name of the database table and its columns that stores the data. Alternatively, the multivariate data may be stored in a file or database residing on a different network device, and the request of the client device 110 may specify the address of the network device and information identifying the location of multivariate data in this device. As an example, the request issued by the client device 110 may also specify a time interval relating to the forecast (e.g., 3 months, 6 months, 7-12 months), and various other information. In an embodiment, the client device 110 provides a graphical user interface (GUI) 111 which facilitates input of the abovementioned information, and display of the final forecast when in its constructed. Furthermore, the GUI 111 can support an analyzation tool, which allows for detail analysis of the generated forecast and performance data. As an example, as an aspect of the analyzation tool, the GUI 111 can provide an interactive display for comparing the past performance of a particular product in a specific region over different time horizons. Another application of the analyzation tool is comparing the forecast produced by the demand forecast server 120 to a different forecast, for instance a forecast that is used by a planning or sales division. By performing a forecast comparison, opportunities for improving product delivery and key areas of focus relating to demand and/or supply may be identified.

The advanced analytics forecasting analyzer 125 is configured to create a multivariate environment, by leveraging market, economic, and customer supply chain data (as channel inventory level). Each of these variables can have their unique prediction value. For example, the market trends at a specific region, product segment (e.g., blades, racks, towers), processor capabilities (1P, 2P, 4P), as well as the market segment share and cloud service provide penetration are all relevant aspects of the supply chain. Thus, each of these aspects can be variables used in creating the multivariate environment. The model uses data from an IDC Server Tracker for the market historical model perspective. In some cases, buying behavior is influenced by regional economic conditions. Thus, a selection of primarily leading economic indicators at a regional level can be used to enhance the model. Additionally, the model can use internal data not leveraged by many existing forecasting approaches, including customer insights, customer install base, and channel inventory.

According to the embodiments, the advanced analytics forecasting analyzer 125 implements several unique capabilities, which allows the system 100 to provide enhanced forecasting. The capabilities of the advanced analytics forecasting analyzer 125 include, but are not limited to: creating a multivariate environment that considers market, economic, customer, and SC data sources; leveraging historical lifecycle analytics (proportional analytics) as part of the model, for the complete lifecycle; leveraging an extended window of historical data for both market and internal shipments (e.g., 15 years); generating the advanced analytics hyper parameter model 122; and leveraging a fully automated environment (versus a semi-automated process for statistical forecast).

The advanced analytics hyper parameter model 122 can be configured to provide enhanced modeling of multivariate data that is based on a combination of time series, machine learning, and deep learning algorithms. Thus, the advanced analytics hyper parameter model 122 is an advanced data modeling technique, as compared to currently employed models for forecasting, which are typically based on statistics. As a general description, the advanced analytics hyper parameter model 122 can model long term trends from the multivariate data in a line level (e.g., specific to a product line) initially, and then split the line volumes across multiple families (or generations) using lifecycle rates, generating predictions that are ultimately used to drive the forecast. To further benefit from the predictive power of product life cycles, the advanced analytics hyper parameter model 122 can include an expanded time window, for instance analyzing over 15 years of data (representing 7 cycles). This allows the advanced analytics hyper parameter model 122 to capture, not only a complete cycle (as compared to only a partial horizon in conventional forecast approaches), but multiple cycles, further enhancing the model 122. Even further, as alluded to above, the multivariate environment, including market data, economic data, and the like, improves the training of the model 122.

In some embodiments, the advanced analytics hyper parameter model 122 can include a unit level deal predictor, as an additional enhancement. Deal prediction aspects can be implemented by leveraging customer analytics on their purchasing behaviors with recent deal data from sales. Deal prediction can improve the advanced analytics hyper parameter model 122, by allowing the model to capture data indicative of deals variability and related to demand influence.

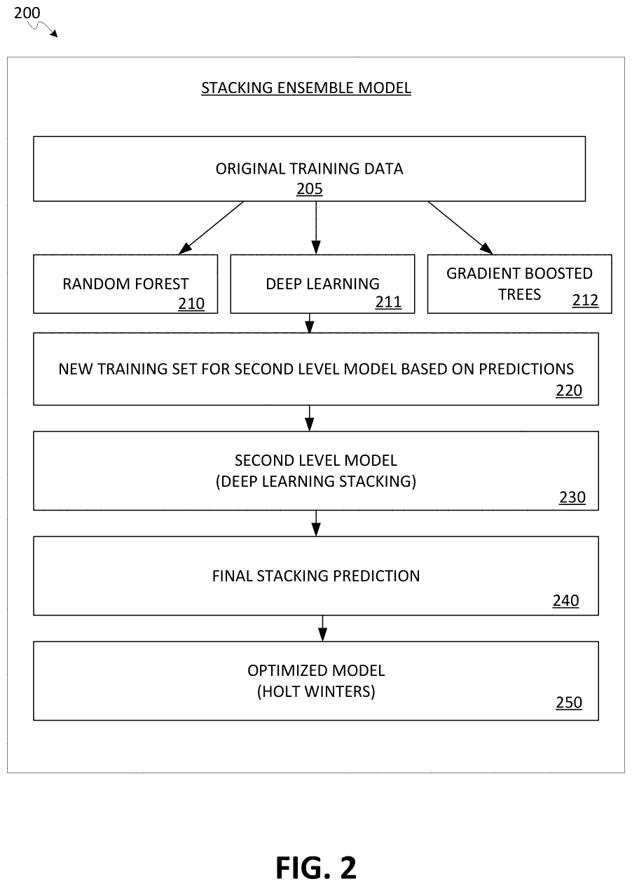

Additionally, the advanced analytics hyper parameter model 122 can utilize time-series approaches, based on autoregressive integrated moving average (ARIMA) technique. Time series data can be transformed into a windowed set allowing processing by machine learning algorithms. In some embodiments, the advanced analytics hyper parameter model 122 is configured to train a learning algorithm to combine the predictions of several other learning algorithms using a stacking ensemble technique, thereby improving the modeled predictions. An example of the advanced analytics hyper parameter model 122 implemented as a stacking ensemble model is discussed in greater detail in reference to FIG. 2.

On a high-level, the advanced analytics hyper parameter model 122 is built for flexibility. For example, the advanced analytics hyper parameter model 122 can be configured to include up to six different models that interact with each other to enhance accuracy, as well as enable the other metrics reporting within the supply chain. In other words, the advanced analytics hyper parameter model 122 can be an aggregation of individual models. According to this embodiment, the advanced analytics hyper parameter model 122 can include: a market sizing and economics dynamics model, representing the market and economic impact on server demand; an ALFA deal predictor model, representing unit level deal predictions; replacement cycle assessment model, representing replacement cycle and demand dynamics; line level dynamics model, representing the an expected line level demand; family level (ramp rate proportions) model, representing expected family level demand; and SKU level demand, representing SKU demand and options interface data. By applying multivariate data to modeling, using different types of data capturing different aspects that impact demand (and supply chain), the advanced analytics hyper parameter model 122 expands the algorithm, making the model 122 stronger, more sophisticated, and enhanced over some conventional forecasting and prediction models. Further, by analyzing and modelling various types of data, the advanced analytics hyper parameter model 122 can increase its compatibility and usefulness across a wider range of practical applications.

In an embodiment, the advanced analytics hyper parameter model 122 can be implemented as a multivariate ARIMA model. An ARIMA model is generally low complexity, as compared to stack ensemble models. However, to adjust for the simplicity, the number of inputs may be reduced.

Referring back to the example, the demand forecast server 120, including the advanced analytics hyper parameter model 122, and the advanced analytics forecasting analyzer 125, can perform the forecasting in response to the request of the client device 110. In the illustrated example, the advanced analytics forecasting analyzer 125 is shown as the component that performs the data analysis, such as modeling and predicting, which ultimately provides the forecast. As previously described, the multivariate data that may be fed into the advanced analytics forecasting analyzer 125 for analysis can pertain to a variety of related factors, including but not limited to: market data, econometric data, customer data, and supply chain data sources. A key factor to the enhanced analytics capabilities is the inclusion of lifecycle data. That is, the advanced analytics forecasting analyzer 125 considers life cycle for products in its analysis to improve the forecast. Life cycle can have significantly less variability than actual demand, making life cycle a good predictor of demand throughout the complete life cycle of the product.

In FIG. 1B, an example of a display 150 that may be provided by a GUI (shown in FIG. 1A) via the analyzation tool is shown. As an example, the analyzation tool can generate visuals that illustrate comparisons between the advanced analytics demand forecast generated by the system (shown in FIG. 1A) and the current forecast. This information in display 150 can useful in conveying improvement points, for instance informing planners and providing a visual for management to review progress. Display 150 depicts that analysis can generally be performed on two levels via the analyzation tool, for the upcoming forecast cycle and for historical trends.

In FIG. 1C, another example of a display 160 that may be provided by a GUI (shown in FIG. 1A) via the analyzation tool is shown. The display 160 shows visual representation of long term trends for ramp proportions that can be generated by the system (shown in FIG. 1A). This feature can help improve accuracy, by including long term trends in the model and in the visuals of display 160 that can be viewed by planners for their benefit. The analyzation tool may be configured to support additional features and visuals not described herein, for purposes of brevity. For example, the analyzation tool may include a visual that reflects market perspective, which provides planners with insights into the latest market developments.

Referring now to FIG. 2, an example of a model 200 that can be applied to implement the disclosed advanced analytics demand forecasting techniques is depicted. In the example, the model 200 is configured as a stacking ensemble model, which combines the predictions of several other learning algorithms, as alluded to above. As background, ensembles are a divide and conquer approach used to improve performance. The model 200 uses an ensemble method, by using multiple models to obtain a better predictive performance than could be obtained from any of the constituent models. In other words, an ensemble is a technique for combining many simple algorithms in an attempt to produce a stronger algorithm having greater complexity. Evaluating the prediction of an ensemble typically requires more computation than evaluating the prediction of a single model, so ensembles may be thought of as a way to compensate for poor learning algorithms by performing a lot of extra computation.

An ensemble is itself a supervised learning algorithm, because it can be trained and then used to make predictions. The trained ensemble, therefore, represents a single hypothesis. This hypothesis, however, is not necessarily contained within the hypothesis space of the models from which it is built. Thus, ensembles can be shown to have more flexibility in the functions they can represent. This flexibility can, in theory, enable them to over-fit the training data more than a single model would, but in practice, some ensemble techniques (especially bagging) tend to reduce problems related to over-fitting of the training data.

Empirically, ensembles tend to yield better results when there is significant diversity among the models. Many ensemble methods, therefore, seek to promote diversity among the models they combine. Although perhaps non-intuitive, more random algorithms (like random decision trees) can be used to produce a stronger ensemble than very deliberate algorithms (like entropy-reducing decision trees). Using a variety of strong learning algorithms, however, has been shown to be more effective than using techniques that attempt to dumb-down the models in order to promote diversity.

In FIG. 2, the stacking ensemble model 200 receives original training data 205, which can be the multivariate data relating to markets, econometrics, and supply chain, as previously described. This original training data 205 flows into three models, namely a random forest model 210, a deep learning model 211, and a gradient boosted trees model 212. The models 210, 211, and 212 can be trained on the original training data 205 yielding predictions. Predictions from the models 210, 211, and 212 can then be used to generate a new training set 200 (based on the predictions). This new training set 220 derived from predictions can be used to train a second level model 230. The second level model 230 can be a deep learning stacking model. The trained second model 230 generates final stacking prediction 240. By applying the stacking ensemble approach, the combined algorithm from the first level and second level models can generally yield a significantly better performance than any single trained model. Accordingly, the final stacking prediction 250 may have improved accuracy.

In addition, the model 200 can compare the final stacking prediction 250, which is the result of the aggregate models 210, 211, 212, and 230 of the stacking ensemble with an optimized model 260. In the example, the optimized model 260 is a Holt Winters model. As referred to herein, Holt-Winters is a technique in forecasting that can predict the behavior of a sequence of values over time—in a time series. Holt-Winters is one of the most commonly used forecasting techniques for time series. Based on the comparison of the optimized model 260 to the final stacking prediction 250, the model 200 outputs a forecast. Consequently, the forecast generated by the stacking ensemble model 200 is enhanced by advanced optimization and analytics techniques. It should be appreciated that the structure of the stacking ensemble model 200 is not limited to the example of FIG. 2, and can include other types of models, such as k-Nearest Neighbors (k-NN) models, and multi-layer feed forward artificial neural network models, in the stacking ensemble.

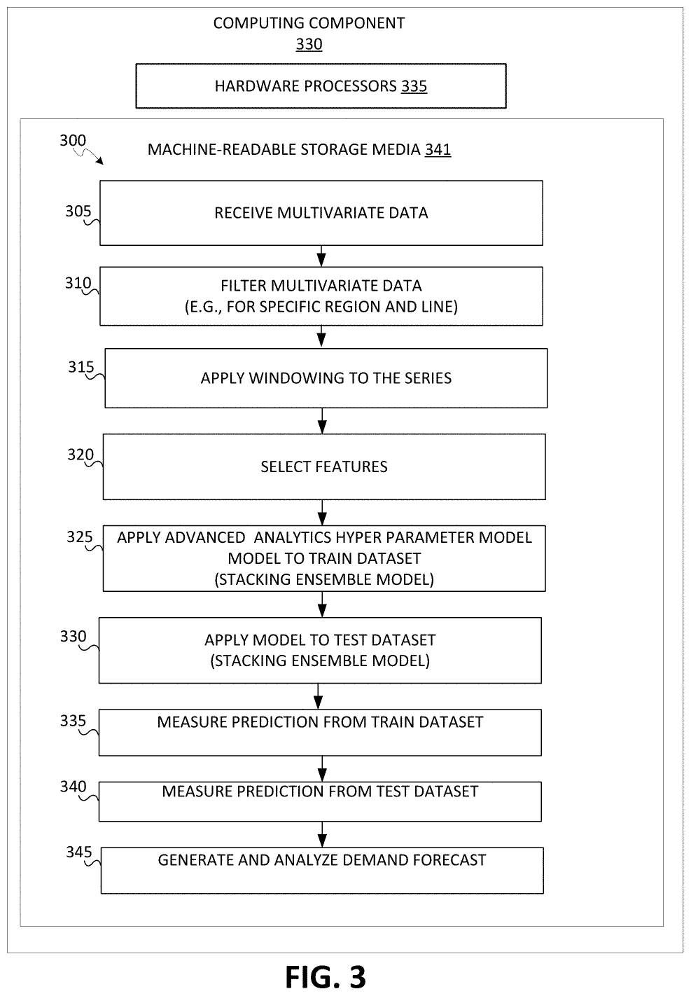

Further details of the advanced analytics demand forecast features are now described with reference to FIG. 3, which illustrates an example of a process 300 according to one embodiment of the systems and methods described herein. As seen in FIG. 3, process 300 is illustrated as a series of executable operations in a machine-readable storage media 341 performed by a hardware processor 335. The computing component 330 can be a demand forecast server (shown in FIG. 1A) implementing demand forecasting capabilities, as previously described. Generally, the process 300 forecasts at a line level, and estimates lifecycle proportions (excluding feature selection), and ultimately generates a family level forecast by combining the line level forecast and lifecycle estimation.

In an operation 305, multivariate data is received for processing. In some cases, the data can be received from a data storage (e.g., database) that may be local to a system (shown in FIG. 1A) implementing the process 300. Further, the multivariate data can comprise data that relates to, or otherwise impacts, aspects of the supply chain. The multivariate data received in operation 305 can include, but is not limited to: market data; econometric data; customer data; supply chain sources data; and lifecycle data. The multivariate data, in some instances, is vast amounts of data that can be received from multiple different sources, such as company records, consumer tracking, and data provided by third party sources.

Next, at operation 310, the multivariate data can be filtered such that particular information is separated from the larger pool of multivariate data that may be obtained in previous operation 305. For example, the data may be filtered for specific region and line.

Thereafter, the process 300 can proceed to operation 315, where windowing is applied to the series. Operation 315 can involve converting time series data into a windowed example set. This example set can be processed with standard machine learning methods.

At operation 320, features are selecting. As an example, the top 90-100 variables are screened and selected for modeling. After the selection, the process 300 can apply an advanced analytics hyper parameter model to a train dataset in operation 325. In the example, operation 325 specifically applies a stacking ensemble model, as previously described in detail in reference to FIG. 2. Accordingly, operation 325 can involve training a K-NN model, Random Forest model, GBT model, and Deep Learning model using the train dataset. Furthermore, as alluded to above, the models are applied in a combined manner, rather than choosing one model among the group. Thus, by using the ensemble stacking approach, applying the model in operation 325 drives improved performance (as compared to any individual of the trained models).

Additionally, process 300 applies a model to a test dataset in operation 330. As a result, predictions generated from modeling the train dataset in operation 325 can be measured in operation 335. Similarly, the predictions generated from modeling the train dataset in operation 325 can be measured in operation 335. In an embodiment, operations 335 and 340 generates a Mean Absolute Percentage Error (MAPE), which uses weighted forecast metric with diverse demand patterns.

Subsequently, in operation 345, the predictions from previous operations 335 and 340 can be used to generate a demand forecast. This demand forecast can also be analyzed, in operation 345, which allows for issues regarding performance and improving supply chain metrics to be identified. For example, operation 345 can involve employing an analyzation tool providing visuals to better inform planners on a current position when compared to the generated forecasts with the current forecasts.

Accordingly, process 300 implements an improved forecasting approach, which is generally free from significant bias and improves over time. Further, the process 300 uses an approach that focuses on root causes of big errors. For example, the process 300 employs broader data (lifecycle data, multivariate data, long term data), dollarizes and prioritizes deltas versus current forecast, and includes a built-in CPI and improvement tracking. The process 300 can utilize a coefficient of volatility, which categorizes demand by forecastability. Even further, process 300 uses sales data for a more collaborative forecasting approach. Lastly, the process 300 leverages demand shaping, by considering improved market and demand data (e.g., helps enable demand shaping), and leveraging deals data as part of the process (not ad-hoc).

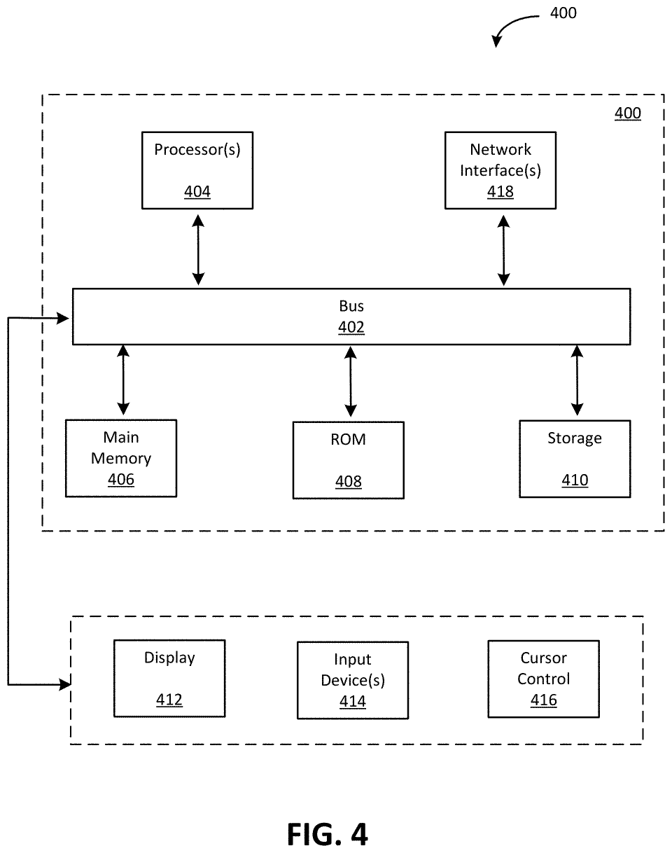

FIG. 4 depicts a block diagram of an example computer system 400 in which the advanced analytics demand forecasting embodiments described herein may be implemented.

The computer system 400 includes a bus 402 or other communication mechanism for communicating information, and one or more hardware processors 404 coupled with bus 402 for processing information. Hardware processor(s) 404 may be, for example, one or more general purpose microprocessors.

The computer system 400 also includes a main memory 408, such as a random-access memory (RAM), cache and/or other dynamic storage devices, coupled to bus 402 for storing information and instructions to be executed by processor 404. Main memory 408 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions. The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor 404 may be programmed by one or more additional instructions that may perform some or all of the functionality attributed herein to one of the instructions.

The computer system 400 further includes storage device 410. The various instructions described herein, including the advanced analytics demand forecasting techniques, may be stored in a storage device 410, which may comprise read only memory (ROM), and/or other static storage device coupled to bus 402 for storing static information and instructions for processor 404. A storage device 410, such as a magnetic disk, optical disk, or USB thumb drive (Flash drive), etc., is provided and coupled to bus 402 for storing information and instructions. The storage device 410 may store the computer program instructions (e.g., the aforementioned instructions) to be executed by processor 404 as well as data that may be manipulated by processor 404. The storage device may comprise one or more non-transitory machine-readable storage media such as floppy disks, hard disks, optical disks, tapes, or other physical storage media for storing computer-executable instructions and/or data.

The computer system 400 may be coupled via bus 402 to a display 412, such as a liquid crystal display (LCD) (or touch screen), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. In some embodiments, the same direction information and command selections as cursor control may be implemented via receiving touches on a touch screen without a cursor.

The computing system 400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor(s) 404 executing one or more sequences of one or more instructions contained in main memory 408. Such instructions may be read into main memory 408 from another storage medium, such as storage device 410. Execution of the sequences of instructions contained in main memory 408 causes processor(s) 404 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 608. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 402. Transmission media can also take the form of acoustic or light waves, such as those generated during radio-wave and infra-red data communications.

The computer system 400 also includes a communication interface 418 coupled to bus 402. Network interface 418 provides a two-way data communication coupling to one or more network links that are connected to one or more local networks. For example, communication interface 418 may be an integrated service digital network (ISDN) card, cable modem, satellite modem, or a modem to provide a data communication connection to a corresponding type of telephone line. As another example, network interface 418 may be a local area network (LAN) card to provide a data communication connection to a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. Wireless links may also be implemented. In any such implementation, network interface 418 sends and receives electrical, electromagnetic or optical signals that carry digital data streams representing various types of information. The nodes of the decentralized model building system, as disclosed herein, may be coupled to other participant nodes via the abovementioned networks.

A network link typically provides data communication through one or more networks to other data devices. For example, a network link may provide a connection through local network to a host computer or to data equipment operated by an Internet Service Provider (ISP). The ISP in turn provides data communication services through the world-wide packet data communication network now commonly referred to as the “Internet.” Local network and Internet both use electrical, electromagnetic or optical signals that carry digital data streams. The signals through the various networks and the signals on network link and through communication interface 718, which carry the digital data to and from computer system 700, are example forms of transmission media.

The computer system 400 can send messages and receive data, including program code, through the network(s), network link and communication interface 418. In the Internet example, a server might transmit a requested code for an application program through the Internet, the ISP, the local network and the communication interface 418.

The received code may be executed by processor 404 as it is received, and/or stored in storage device 410, or other non-volatile storage for later execution.

The various processes, methods, operations and/or data flows depicted in FIG. 3 (and in the other drawing figures) described in the preceding sections may be embodied in, and fully or partially automated by, code components executed by one or more computer systems or computer processors comprising computer hardware. The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 400.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
filtering multivariate data received from a datastore, wherein the multivariate data comprises a plurality of data relating to demand in a supply chain;
applying windowing to the filtered multivariate data, wherein windowing creates a train dataset comprising a plurality of time windows to be processed by a machine learning model;
applying a machine learning model to the train dataset, wherein applying the machine learning model comprises training the machine learning model using the train data to generate a prediction;
measuring the predication based on the train dataset; and
generating a demand forecast based on the measured prediction, wherein the generated demand forecast is usable for analyzing metrics of the supply chain.

2. The method of claim 1, wherein the multivariate data comprises: market data; customer data; lifecycle data; econometric data; historical demand data; and data from supply chain sources.

3. The method of claim 2, wherein the historical demand data comprises data covering a time window of at least a 15 years.

4. The method of claim 3, further comprising:
applying a machine learning model to a test dataset, wherein applying the machine learning model comprises training the machine learning model using the test data to generate a test prediction;
measuring the test predication based on the test dataset; and
comparing the test prediction based on the test dataset to the prediction based on the train dataset.

5. The method of claim 1, wherein the machine learning model comprises an advanced analytics hyper parameter model.

6. The method of claim 5, wherein the machine learning model comprises a stacking ensemble model.

7. The method of claim 5, wherein the machine learning model comprises a multivariate autoregressive integrated moving average (ARIMA) model.

8. The method of claim 1, wherein filtering the multivariate data comprises:
filtering to obtain data corresponding to a specific region and data corresponding to a specific product line.

9. The method of claim 8, further comprising:
selecting features from the filtered multivariate data to be modeled by the machine learning model.

10. A method, comprising:
training a first level of machine learning models using a first dataset of training data;
generating predictions based on the first level of machine learning models;
creating a second dataset of training data based on the predictions;
training a second level machine learning model using the second dataset of training data;
generating a final stacking prediction based on the second level machine learning model; and
comparing the final stacking prediction to an optimized model to produce a demand forecast relating to demand for a product in a supply chain.

11. The method of claim 10, wherein the first level of machine learning models comprises: a random boosted trees model; a deep learning model; and a random forest model.

12. The method of claim 11, wherein the deep learning model comprises a k-Nearest Neighbors (k-NN) model.

13. The method of claim 10, wherein the second level of machine learning models comprises a deep learning stacking model.

14. The method of claim 13, wherein the deep learning stacking model comprises a feed-forward artificial neural network model.

15. The method of claim 10, wherein the first dataset of training data comprises multivariate data capturing multiple life cycles of the product in the supply chain.

16. A system, comprising:
a communications network;
a client device commutatively coupled to the communications network;
a network device communicatively coupled to the client device via the communications network, wherein the network device comprises:
a processor, which when executing instructions programs the processor to:
filter multivariate data received from a datastore, wherein the multivariate data comprises a plurality of data relating to demand in a supply chain;
apply windowing to the filtered multivariate data, wherein windowing creates a train dataset comprising a plurality of time windows to be processed by a machine learning model;
apply a machine learning model to the train dataset, wherein applying the machine learning model comprises training the machine learning model using the train data to generate a prediction;
measure the predication based on the train dataset; and
generate a demand forecast based on the measured prediction.

17. The system of claim 16, wherein the client device comprises:
a processor, which when executing instructions programs the processor to:
receive the demand forecast from the network device; and
in response to receiving the demand forecast, present an interactive graphical user interface (GUI) for analyzing metrics of the supply chain using the demand forecast.

18. The system of claim 16, wherein the multivariate data comprises: market data; customer data; lifecycle data; econometric data; historical demand data; and data from supply chain sources.

19. The system of claim 16, wherein the machine learning model comprises an advanced analytics hyper parameter model.

20. The system of claim 19, wherein the advanced analytics hyper parameter model comprises time series algorithms, machine learning algorithms, and deep learning algorithms.
